(19) United States
(12) Patent Application Publication
(10) Pub. No.: US 2026/0268209 A1
(43) Pub. Date: Sep. 10, 2026

(54) AUTONOMOUS GENERATION OF ANOMALY DETECTION MODELS

(71) Applicant: Schlumberger Technology Corporation, Sugar Land, TX (US)

(72) Inventors: Indranil Roychoudhury, Menlo Park, CA (US); Prasham Sheth, Menlo Park, CA (US); Salma Benslimane, Menlo Park, CA (US); Tejas Yogesh Deo, Houston, TX (US)

(21) Appl. No.: 19/073,499

(22) Filed: Mar. 7, 2025

(51) Int. Cl. G06N 20/00

(52) U.S. Cl. CPC G06N 20/00

(57) ABSTRACT

Certain aspects of the disclosure provide systems and methods for generating anomaly detection (AD) models. A method includes obtaining data comprising at least one input and at least one output, the at least one input and the at least one output associated with a target system; performing triage to determine an AD algorithm framework (AD framework) from a set of AD frameworks, wherein the AD framework is based on the at least one input and the at least one output and wherein the AD framework comprises one or more AD training algorithms; training one or more AD models based on the one or more AD training algorithms of the AD framework; and rank ordering the one or more AD models based on a benchmark set of data associated with the target system.

### CROSS-REFERENCE TO RELATED APPLICATIONS

The U.S. patent application Ser. No. 18/946,097, titled “Unified Hybrid Modeling Tool for Systems of Interest”, filed on Nov. 13, 2024, is in its entirety hereby incorporated by reference.

### BACKGROUND

### Field

Aspects of the present disclosure relate to autonomous generation of anomaly detection models for systems of interest.

### Description of Related Art

Anomaly detection (AD) techniques are used in various industries and may be performed by AD models to monitor and maintain system functions across industries. For example, AD can be used to detect deviations from expected values or to detect outliers in a data set. The flexibility of AD allows these models to be deployed in various contexts, for example, in detecting unexpected events or failures in vehicles, machinery, devices, and network operations to name just a few.

AD models employing may be used in conjunction with artificial intelligence (AI) and machine learning (ML) models. For example, AD models may be trained by various ML techniques. AD models and techniques may also be used on ML models and their associated data. For example, using AD models with ML models and their data may improve data quality, since AD models may detect or remove outliers to reduce errors in the data set. AD models may also optimize ML model performance by identifying anomalies to allow ML models to fit the underlying data instead of being affected by noise from outliers.

Anomalies can be intentional, e.g., caused due to events or actions, or unintentional, e.g., caused due to errors. Anomalies can include point anomalies, contextual anomalies, or collective anomalies. Point anomalies are unique outliers in that they may be extreme in how they differ from one or more characteristics of the data set, e.g., from mean, median values, or expected ranges. Contextual anomalies may be data points that are not anomalous except when viewed in a specific context. For example, a much higher power consumption in a workplace during regular work days compared to a public holiday when employees are not in the building is a contextual anomaly. Collective anomalies are anomalies that are anomalous when viewed collectively, but may otherwise fall within the norms of the data-set when viewed individually. An irregular heart beat is one example of a collective anomaly, where when viewed individually the heartbeat may seem normal, but when viewed amongst other heartbeats, the heart beat is anomalous.

In some implementations, an AD model outputs a binary classification of whether data output of a system is nominal or not, which may indicate whether a system is performing nominally. If the number of classes is more than two, e.g., other than “nominal” and “anomalous,” then an AD model can also be used for fault isolation, which involves identifying the root-cause of the anomaly. For example, if a machine's vibration levels nominally remain below 0.6 mm/s, and if vibration levels increase above this nominal level by 0.1 mm/s, then the AD model may label it as “slightly anomalous,” but if the vibration levels are above the nominal value by more than 0.1 mm/s, then it may be labeled as “anomalous”. The classifications by an AD model may allow for more complex fault isolation, instead of just binary differentiation e.g., allows the use of the additional number of classes (e.g., slightly anomalous and anomalous) to determine a root cause of the problem, for example a slightly anomalous vibration level may be attributed to an increase in temperatures but not component faults, while anything above the vibration level in the slightly anomalous classification (e.g., a classification of anomalous), may be attributed to component faults.

### SUMMARY

One aspect provides a method of obtaining data comprising at least one input and at least one output, the at least one input and the at least one output associated with a target system; performing triage to determine an anomaly detection (AD) algorithm framework (AD framework) from a set of AD frameworks, wherein the AD framework is based on the at least one input and the at least one output and wherein the AD framework comprises one or more AD training algorithms; training one or more AD models based on the one or more AD training algorithms of the AD framework; and rank ordering the one or more AD models based on at least one of a benchmark set of data associated with the target system, pre-set metrics, or user-defined values.

Other aspects provide processing systems configured to perform the aforementioned method as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system deploying an anomaly detection (AD) modeling tool.

FIG. 2 depicts an example triage process of the AD modeling tool.

FIG. 3 depicts an example table 300 illustrating the ruleset for how data types are used to perform triage.

FIG. 4 depicts an example method for generating anomaly detection models.

FIG. 5 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for autonomous generation of anomaly detection models for target systems.

AD models identify patterns or instances that deviate from the norm, potentially indicating unexpected events or actions, malicious activity, or system failures, as a few examples. Conventionally, AD models are developed for specific use cases and are not generalizable. Consequently, each time a new use case arises, a new AD model must be developed, which leads to wasteful resource usage (e.g., compute, power, network traffic, data storage, etc.).

A practical example of AD model deployment can include a pump system that is being deployed in the field after development in the lab. Data would have been collected on the pump system in the lab during development that allows creation of a simulation model of the pump system. The simulation model represents the system's nominal behavior. Once the pump system is deployed in the field, data from the field is collected and recorded to generate real-life data for the behavior of the system in the field. As the pump system deteriorates with time and use after field deployment, the detection of anomalies becomes quite important. Therefore, AD models should be developed and deployed to detect problems with the pump system. However, the creation of AD models requires compute power, time and data resources for modeling, customizing and designing AD model solutions. The aspects disclosed herein overcome AD model development issues by utilizing AD algorithm frameworks that enhance the AD model generation and fine-tuning process.

Generating AD models may involve multiple computationally intensive tasks during development, integration, and performance evaluation stages. For example, at the development stage, selecting the appropriate algorithms to train the AD model may involve testing several different training algorithms. This can require substantial computational resources for simulations and evaluations. The process of optimizing parameters for different model components typically also requires numerous iterations and continuous iterative tweaking of the AD model, which is computationally demanding. In the conventional process, it is generally only practicable that one training algorithm is used and then continuously tweaked and improved to train an adequately performing AD model.

An integration phase during conventional AD model generation attempts to ensure that different model components work together. This integration phase may require multiple rounds of simulations to understand how the various components of the AD model interact, which increases the difficulty of creating custom AD models for a target system. A technical benefit is also provided by the aspects described herein by improving performance evaluation of AD models.

In addition to technical improvements provided herein in relation to development, integration and performance evaluation stages, other technical benefits arise from the disclosure herein due to the improvements in the various types of AD models capable of being generated. Conventional AD models may be predominantly data-driven and may not integrate system information, but instead rely on generic training or modeling data. System information can include data outputs of a system, e.g., outputs of a target system or associated simulation models. Consequently, conventional AD models may be limited in their applicability and accuracy and may perform particularly poorly in the presence of insufficient or low-quality data (e.g., data with significant noise).

Aspects described herein provide an automated process of generating AD models for a target system and based on the target system or associated data. The AD modeling process automatically selects a suitable AD algorithm framework (AD framework) based on the data types available to it. The selected AD framework may comprise training algorithms (AD training algorithms) and settings to train AD models based on a set of data of one or more data types. In some aspects, the AD modeling process not only automates the generation of AD models, but also automates evaluation and benchmarking of generated AD models in a systematic and repeatable manner. Aspects described herein may autonomously deploy the highest performing generated AD model(s). Alternatively, the generated AD models can be displayed with ranking or benchmarks to allow a user to select the most suitable AD model from the generated AD models. A target system can be any system of interest for which the AD modeling process generates an AD model. A target system can include machines and mechanical systems, natural (e.g., ecological) systems, social or economic systems, and information systems, to name just a few. The proposed AD model creation processes described herein can utilize a simulation model (and its data) as well as field data collected to generate AD model(s).

Beneficially, aspects described herein provide AD modeling processes for autonomous AD model generation applicable to a wide range of target systems. For example, the AD frameworks described herein may autonomously select or determine an AD framework based on inputs associated with a target system. Based on this AD framework, the AD modeling process may automatically perform processes to select AD training algorithms without having to test multiple different AD training algorithms or AD training algorithm combinations. For example, the modeling processes described herein may utilize a triage process that autonomously selects from several AD frameworks associated with the target system and the types of data provided to the target system to generate the AD model. The AD frameworks selected by the triage include pre-designed AD training algorithm combinations known to be integrate well based on provided data types and the intended AD model. The triage process to select the AD framework therefore reduces the amount of testing and computational resources dedicated for simulations and evaluations of different AD training algorithms or combinations.

One technical benefit of the aspects described herein is the ability to generate AD models for a target system based on pre-generated pre-tested AD frameworks. This reduces compute resource usage by eliminating the need to repeatedly recreate system-specific AD models that can be applied to different target systems.

A further technical benefit of the aspects described herein is the production of improved AD models over conventional AD models that perform anomaly detection more effectively by leveraging various types of data. The AD frameworks perform triage to select AD training algorithms to develop AD models using a target system's domain knowledge and data outputs, including by using outputs of simulation models, e.g., hybrid models simulating the target system. These hybrid simulation models may combine mechanistic or scientific system models with ML models, and generate highly relevant context-specific outputs that are then used to perform triage to select AD training algorithms and train the AD models. Thus, an AD framework can utilize a target system's domain knowledge data and thereby reduce the impact of poor training data or noise used to train the AD models. The AD frameworks are therefore able to generate AD model(s) that are capable of producing superior anomaly detection results that have improved accuracy and reliability.

A further technical benefit of the aspects described herein is reducing compute usage during AD model generation by allowing the use of pre-trained AD models that are associated with an AD framework. Once an AD framework is selected, pre-trained models may be obtained, e.g., from a repository, and used for the new model. This allows training AD models without having to build them from the ground up but by using the trained weights of the historical AD models and reducing overall compute resource usage in training and generating the AD model.

The AD modeling processes described herein therefore provide a generalizable framework for automating the generation of new, performant AD models in a systematic and repeatable manner while beneficially reducing compute resource.

### Example Autonomous Streamlined AD Model Generation

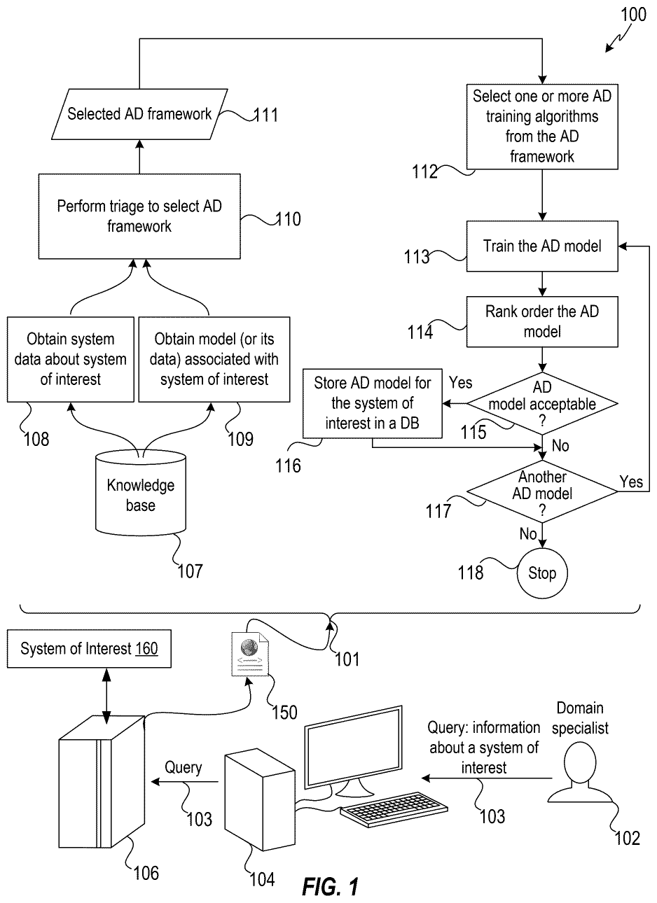

FIG. 1 depicts an example system 100 deploying an AD modeling tool 150. The AD modeling tool 150 can execute a modeling process 101. The AD modeling tool 150 may be software-based, and may be comprised of any one or more of applications, applets, integrated developmental environments, software libraries, data sources, and the like. The system 100 may be associated with or include a target system 160.

A target system 160 may be any type of system that an AD model is to be generated for. The target system 160 could for example include biological or other organic systems, environmental systems, manufacturing production line systems, network systems, medical systems, or any other system that uses or generates data. For example, the target system 160 may also include machinery, vehicles, devices, or other equipment. The target system 160 may be a live system generating data in real-time or it may be a system that has historical data associated with it stored in a database, server, computing storage system, or knowledge base.

The system 100 may include a user device 104, which may be any sort of computing device, including desktop, tablet, and mobile computing devices. The user device 104 may contain or be connected to a display. A user 102, e.g., a domain specialist, inputs 103 a query into the user device 104. For example, the user device 104 displays a user interface (UI) that enables the user 102 to input data. The user input 103 initiates the modeling process 101. In some aspects, the user input 103 may be information or input data about a target system. For example, the user 102 selects on the UI, a specific system or type of system, e.g., the target system 160, to generate an AD model for with the modeling process 101.

The user input 103 is sent to a server system 106. The server system 106 may be a single server, a combination of servers, mainframe, an on-premises server system, a cloud-based server system, an OS type of server or other specialized server(s) (e.g., virtual servers). In some aspects, the server system 106 triggers the AD modeling tool 150 to initiate the modeling process 101. The modeling process 101 may include obtaining data from a knowledge base 107. The knowledge base 107 may comprise any type of a centralized repository of information, e.g., internal organizational databases or documentation platforms.

The AD modeling tool 150 can also obtain system data at block 108 from the knowledge base 107 or the user 102, e.g., via the user input 103. The system data is associated with, or generated from the target system 160 and may be live data or historical stored data. For example, the AD modeling tool obtains input data x or output data y of the target system 160 at block 108. In one example, if the target system 160 was a natural gas reservoir, then the data may include chemical reaction modeling data, or gas volume extraction data. The data obtained at 108 may also be based on system deployment field data or official data, e.g., organizational or governmental published data.

At block 109 the modeling process 101 obtains a model, e.g., the simulation model associated with the target system 160 or data associated with the simulation model or a previously stored AD model. The model can be obtained from the knowledge base 107 or from the user 102, e.g., via the user input 103. The model could include a simulation model that represents the target system 160. For example, the simulation model includes representations of a physical target system, such as the target system 160. The simulation model may include representation(s) of the target system 160's nominal behavior, anomalous behavior, or both. This representation of the system's nominal behavior can be physics-based, data-driven ML-based, or a hybrid of both. A physics based model is derived from the laws of physics or other first-principle scientific knowledge and relies on mathematical equations to model a system and predict its behavior. An ML model learns patterns and relationships in data without having to rely on any scientific principles, but instead uses large datasets to train the model to recognize patterns in the data. A hybrid model typically combines both models. The simulation model may be made up of one or more of the aforementioned models and can include various levels of abstracted physics models, including black-box models, causal-directed acyclic graphs, functional models, and realized models (in order from highest levels of abstraction to lowest levels of abstraction). The simulation model may also be a hybrid model made up from a combination of system model(s) and ML model(s). The simulation model obtained at block 109 may include mechanistic models, statistical models, physical environmental models, physics models, or other scientific models.

In some aspects, the simulation model obtained at block 109 can include previously generated or stored model(s), e.g., previously generated or stored AD model(s) as well as data associated with these AD model(s), allowing the system to use the AD model or its data as initial weights for training purposes, e.g., when training the AD model(s) at block 112, instead of starting with completely new and untrained AD models. For example, if the target system is a pump system, and previous AD models were created and saved for the pump system, then this stored AD model may be obtained at block 109 from the knowledge base 107.

In some aspects, blocks 108 or 109 may be associated with or triggered by the user input 103. In some aspects, obtaining the system data at block 108 and obtaining the simulation data at block 109 may both be optional aspects. For example, only one of block 108 or block 109 occurs, while in other aspects both occur.

At block 110, the AD modeling tool 150 performs a triage to select AD framework(s) 111 associated with the data obtained at block 108 or the simulation model obtained at block 109. The triage at block 110 may include determining AD framework(s) 111 that are suitable based on blocks 108 or 109. The triage at block 110 can include eliminating other AD framework(s) 111 not suitable for the AD model based on the data obtained at block 108, or the simulation model obtained at block 109, or both, and selecting the AD framework(s) to generate the AD model(s).

In some aspects, the AD framework(s) 111 comprise one or more AD training algorithms. The AD training algorithms can be based on ML models, mechanistic or scientific models, or hybrid models combining both ML and scientific models. At block 112, the AD modeling tool 150 selects AD training algorithm(s) from the selected AD framework(s) 111 to train the AD model(s). Example AD training algorithm(s) include one-dimensional convolutional neural network-long short-term memory models (CNN1D-LSTM), variational autoencoder-Long short-term memory model (VAE-LSTM), sequence variational autoencoder-Long short-term memory models (SeqVAE-LSTM), variational autoencoder-bi-directional Long short-term memory models (VAE-BiLSTM), sequence variational autoencoder bi-directional Long short-term memory models (SeqVAE-BilSTM), an isolation forest, a one class support vector machine (SVM), Local outlier factor models, Gaussian mixture models, and a Long short-term memory (LSTM) models.

At block 113, the AD modeling tool 150 trains AD model(s) based on the training algorithm(s) designated by the AD framework(s) 111. Training the AD model(s) at block 113 can include training an ML model using a dataset, e.g., the data retrieved at blocks 108 or 109. During training at block 113, the AD model(s) can learn patterns and relationships between the data where parameters are adjusted to minimize the difference between targets and training data.

The training at block 113 can include validating the AD model(s), which includes tuning the model, e.g., tuning its hyperparameters, by using a different dataset to the training dataset used at block 112. Validation can be performed to help prevent overfitting so that the generated AD model(s) can be applied to a wide-range of data sets and contexts.

The training at block 113 can also include the AD modeling tool 150 testing the generated AD model(s). This may include evaluating the AD model(s) on a test data set that may be a second data set obtained at blocks 108 or 109 or otherwise obtained by the AD modeling tool 150. Testing the AD model(s) assesses how well they generalize to new, unseen data, providing an estimate of model performance in real-world scenarios.

The trained AD model(s) are then benchmarked, or rank ordered at block 114 to determine the most suitable or appropriate AD model(s) for the target system 160. The ranking can be based on performance metrics obtained during the training stage or benchmarking at block 114 for each trained AD model. Each of the AD framework(s) 111 includes its own benchmark test(s) or predefined benchmark values. Rank ordering at block 114, e.g., based on benchmarking of the AD model(s), can be applied for multiple generated AD models, which also include other AD models, e.g., off-the-shelf commercial AD models, or previously generated or stored AD models.

The benchmarking at block 114 can include predefined evaluation and benchmarking tests to classify or identify acceptable models or to rank the generated AD model(s). Evaluation metrics for the evaluation and benchmarking tests can include user defined metrics based on the equipment and the business needs. Additionally, any standard metric for classification can be used, such ROC-Score, an F1-Score, etc., for evaluating of the AD model(s). For example, based on the user defined metrics, the relevant AD model(s) are evaluated on the test data and the various metrics are computed to identify the best suitable algorithm. All of this information is retained for future benchmarking whenever a similar system is given by the user in the future.

Based on the results of block 114, the AD modeling tool 150 makes a determination at block 115 on whether a generated and ranked AD model of the generated and ranked AD model(s) is acceptable. This determination may be based on pre-defined performance metrics of outputs of the AD model(s). The benchmarks to determine if the AD model(s) are performant are associated with the AD framework(s) 111 or with other benchmarks, e.g., benchmarks retrieved from the knowledge base 107. If the AD model(s) meet pre-defined benchmark(s), at block 116 they are stored in a database, e.g., for future use by the AD modeling tool 150.

At block 117, the AD modeling tool 150 determines whether additional AD model(s) should be trained. The total number of AD model(s) required can be based on a configuration of the user 102 or obtained as part of the user input 103, or be associated with the AD framework(s) 111. For example, each AD framework(s) 111 can set a certain number of AD model(s) to be trained when the AD framework(s) 111 are selected. If the AD modeling tool 150 determines at block 117 that additional AD model(s) should be generated, for example because there are not enough acceptable AD model(s) (e.g., as determined at block 115) generated, then blocks 113-115 are applied to other AD model(s).

The modeling process 101 stops at block 118, if the AD modeling tool 150 determines at block 117 that a sufficient number of acceptable hybrid models have been generated.

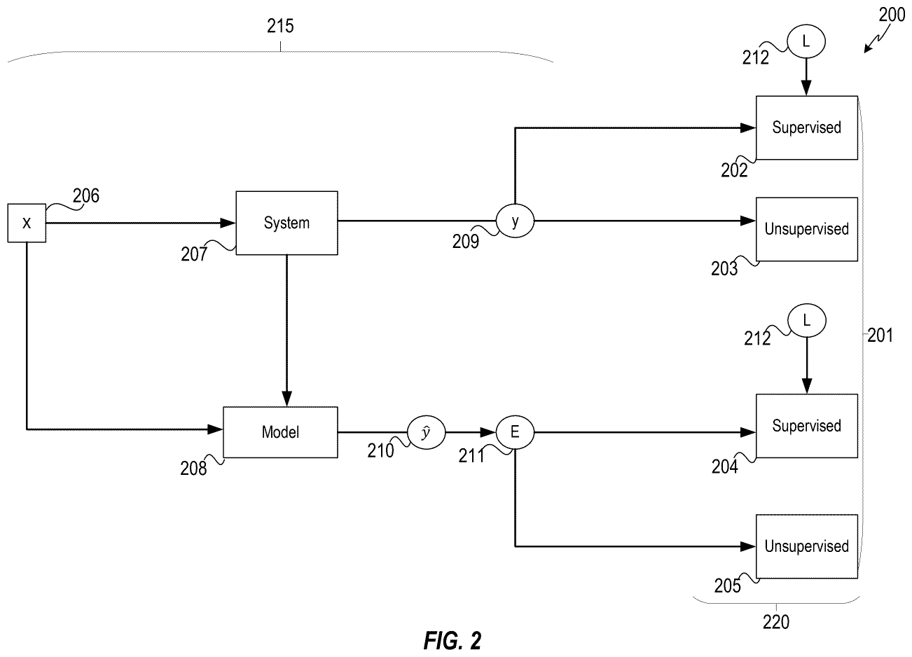

FIG. 2 depicts an example triage process 200 of the AD modeling tool. The example triage process 200 may correspond with block 110 of FIG. 1. The AD modeling tool may correspond to the AD modeling tool 150 of FIG. 1.

The example triage process 200 selects a specific AD framework of a set 201 of AD frameworks, wherein each AD framework comprises one or more AD training algorithms. The set 201 may include a non-residual-based supervised learning (NR-SL) AD framework 202, a non-residual-based unsupervised learning (NR-UL) AD framework 203, a residual-based supervised learning (RB-SL) AD framework 204, and a residual-based unsupervised learning (RB-UL) AD framework 205.

The example triage process 200 automatically uses the available data associated with a target system 207 or a simulation model 208 (e.g., a simulation model 208 of the target system 207) to determine or select 220 the AD framework from the set 201 of AD frameworks. The example triage process 200 at 215 classifies the data it has available to it, e.g., data from blocks 108 or 109 of the modeling process 101 of FIG. 1, or otherwise form the user input 103 or the knowledge base 107 of the system 100 of FIG. 1. The classifying of the available data at 215 by the example triage process 200 includes classifying the data into one or more types including any of input(s) x 206 (inputs of the target system 207 or of the simulation model 208), output(s) y 209 of the target system 207, output(s) ŷ 210 of the simulation model 208, or label(s) L 212. A residual value E 211 may be determined during the example triage process 200 or otherwise by the AD modeling tool 150 of FIG. 1. The residual value E 211 is determined based on a difference between the output ŷ 210 of the simulation model 208 (which represents an expected/predicted output) and the output y 209 of the target system 207 (which represents the actual output of the target system 207).

In all of the residual based learning frameworks (the RB-SL AD framework 204 and the RB-UL AD framework 205) the output ŷ 210 of the simulation model 208 can be used as the input into one or more training algorithm(s) to train the AD model. Furthermore, the output ŷ 210 of the simulation model 208 can be used to fine-tune training data (e.g., before it is used to train the AD model(s)) if the simulation model 208 is associated with additional features/signals that could be informative for the AD model(s) that are to be generated for the target system.

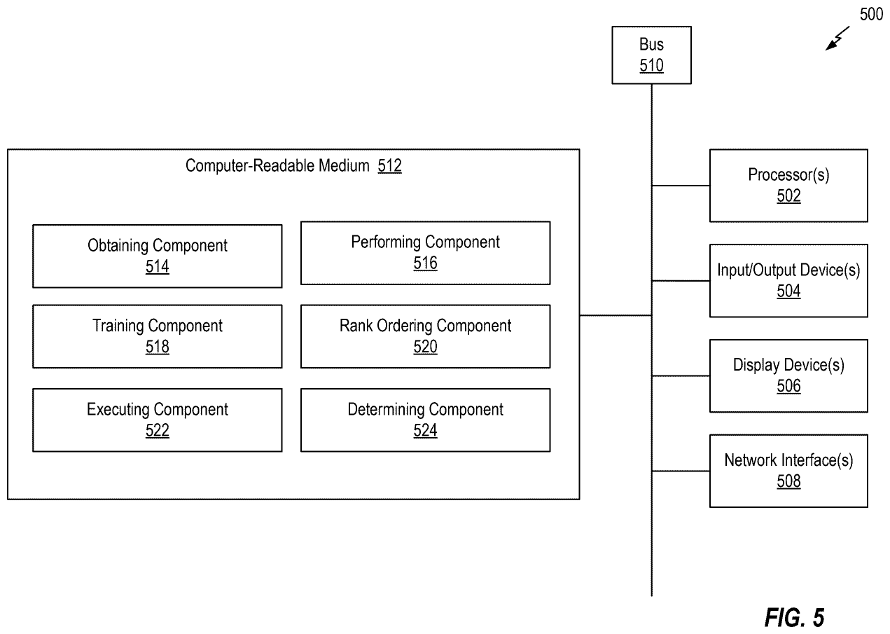

Based on the classifying at 215 of the available data, the example triage process 200 automatically determines, or selects the AD framework(s) of the set 201 of AD frameworks, or eliminates AD framework(s) of the set 201 of AD frameworks from selection. For example, if the output ŷ 210 is not included in the available data that was classified at 215, then the AD frameworks 204 and 205 are eliminated and only the AD frameworks 202 and 203 can be selected from to train and generate the AD model(s). The example triage process 200 is an autonomous process executed by a modeling tool running on a processing system, e.g., the processing system 500 of FIG. 5, that selects the AD framework from the set 201 of AD frameworks that will be used to generate AD model(s) and define AD training algorithms and settings used to train, evaluate, and benchmark the AD model(s). In some aspects, the AD frameworks of the set 201 include predefined evaluations and benchmarking tests for AD model(s) generated by the AD framework.

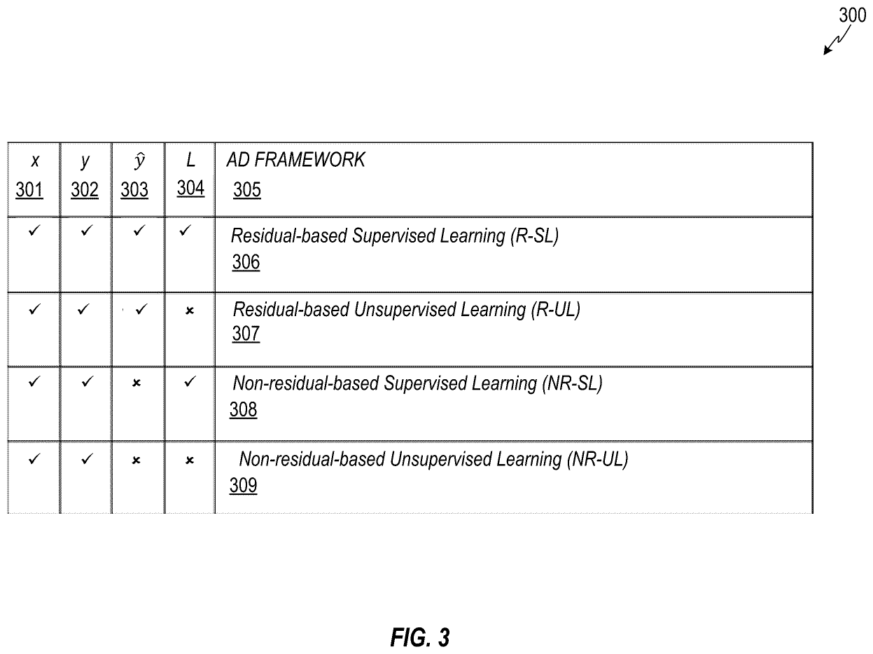

FIG. 3 depicts an example table 300 illustrating the ruleset for how data types available are used to perform the triage. The triage may correspond with the example triage process 200 of FIG. 2.

The example table 300 illustrates the rules used to determine or select each of the AD frameworks, for example at 220 of FIG. 2. The example table 300 includes columns 301-305. Column 301 depicts the availability of data classified as an input x. The input(s) x of the column 301 corresponds to the input(s) x 206 of FIG. 2. Column 302 depicts the availability of data classified as an output y. The output y of the column 302 corresponds to the output(s) y 209 of FIG. 2. Column 303 depicts the availability of data classified as an output(s) ŷ. The output(s) ŷ of the column 303 corresponds to the output(s) ŷ 210 of FIG. 2. Column 304 depicts the availability of data classified as label(s) L. The label(s) L of the column 304 corresponds to the label(s) L 212 of FIG. 2.

Column 305 depicts the AD frameworks, where each row in the column 305 depicts one type of AD framework. Each of the AD frameworks in the column 305 is associated with a type of AD training algorithms. The AD framework can utilize AD training algorithm types based on R-SL 306, R-UL 307, NR-SL 308, and NR-UL 309.

In some aspects, all the AD frameworks listed in the column 305 require the availability of data of types of at least the input x and of the output y. According to the example table 300, when available data include all types listed in the column 301-304, e.g., the input x, the output y, the output ŷ, and the label L then the AD framework that would be selected would be one that utilizes the R-SL 306. The presence of the output y and the output ŷ allow the calculation of the residual (which is the difference between the output y and the output ŷ), while the presence of labels L allows for supervised learning, therefore the AD frameworks selected will be the framework that utilizes R-SL 306 to train the AD model(s). R-SL 306 example AD training algorithms may include a CNN1D-LSTM, a VAE-LSTM, a SeqVAE-LSTM, a VAE-BiLSTM, a SeqVAE-BilSTM, an Isolation Forest model, an SVM, a Local Outlier Factor model, a Gaussian Mixture model, and a Long Short-Term Memory (LSTM) model.

According to the example table 300, when available data includes the types of the input x, the output y, and the output ŷ then the AD framework that would be selected would be framework that utilizes the R-UL 307, since the lack of labels L with the data means that the training of the model cannot utilize supervised learning to train the AD model(s). R-UL 307 example AD training algorithms may include VAE-LSTM, SeqVAE-LSTM, VAE-BiLSTM, SeqVAE-BilSTM, and LSTM.

According to the example table 300, when available data includes the types of the input x, the output y, and the labels L then the AD framework that would be selected would be framework that utilizes the NR-SL 308. The presence of labels L in the data allows for supervised learning, while the lack of output ŷ means that the residual cannot be determined and therefore the AD framework cannot utilize residual-based training to train the AD model(s). NR-SL 308 example AD training algorithms may include CNN1D-LSTM, VAE-LSTM, SeqVAE-LSTM, VAE-BiLSTM, SeqVAE-BilSTM, isolation forest, one class SVM, Local Outlier Factor, Gaussian Mixture Model, and LSTM.

According to the example table 300, when available data only includes the types of the input x, the output y, then the AD framework that would be selected would be framework that utilizes the NR-UL 309. The lack of labels L in the data prevents supervised learning, while the lack of output ŷ means that the residual cannot be determined and therefore the AD framework cannot utilize residual-based training to train the AD model(s). NR-UL 309 example AD training algorithms may include VAE-LSTM, SeqVAE-LSTM, VAE-BiLSTM, SeqVAE-BilSTM, and LSTM.

### Example Method for Autonomous Ad Model Generation

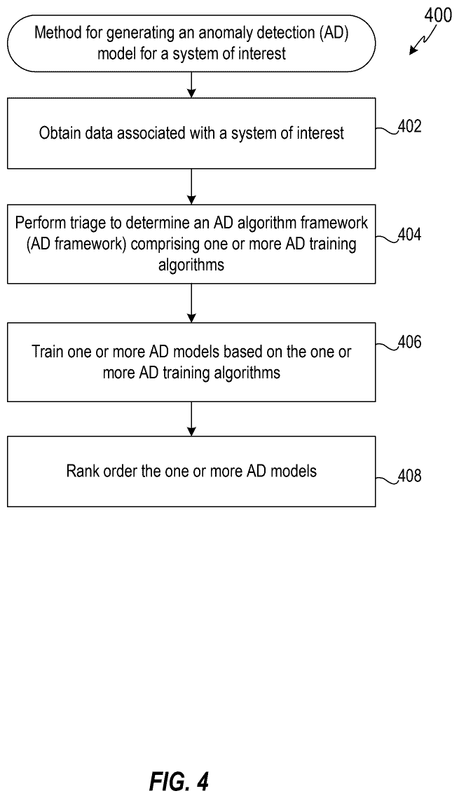

FIG. 4 shows a method 400 for hybrid modeling a target system. In one aspect, method 400 may be performed by a processing system, such as a processing system 500 described with reference to FIG. 5. The method 400 provides a generalizable framework that automates the building of new AD models in a systematic and repeatable manner reducing compute resource usage associated with AD model generation. In some aspects, the method 400 corresponds to the modeling process 101 of FIG. 1.

Method 400 begins at block 402 with obtaining data comprising at least one input and at least one output, the at least one input and the at least one output associated with a target system. Block 402 can correspond to one or both of blocks 108 or 109 or FIG. 1.

The method 400 then proceeds to block 404 with performing triage to select an anomaly detection (AD) algorithm framework (AD framework) from a set of AD frameworks, wherein the AD framework is based on the at least one input and the at least one output and wherein the AD framework comprises one or more AD training algorithms. The triage at 404 can correspond to the triage at block 110 of FIG. 1.

The method 400 then proceeds to block 406 with training one or more AD models based on the one or more AD training algorithms of the AD framework. The AD framework can include any of the frameworks in the set 201 of AD frameworks of FIG. 2. The method 400 provides AD frameworks comprising AD training algorithms known to be integrate well with the type of data provided and the AD model to be generated, reducing any processing or computations to determine integration of models, data, or training algorithms together. The block 406 can correspond to the training of an AD model at block 113 of FIG. 1.

The method 400 then proceeds to block 408 with rank ordering the one or more AD models based on at least one of a benchmark set of data associated with the target system, pre-set metrics, or user-defined values. Block 408 can correspond to block 114 of FIG. 1.

In some aspects, method 400 further includes obtaining a selection of an AD model of the one or more AD models from a user. For example, obtaining a selection via a user input 103 of FIG. 1.

In some aspects, method 400 further includes executing the AD model on at least one data input associated with the target system. For example, the AD model after being trained can be executed to be used to detect anomalies in the target system by being provided real-time output data from the target system and produce an output or result, e.g., an anomaly classification of the target system.

In some aspects, method 400 further includes obtaining one or more stored AD models from a knowledge base, wherein the method 400 comprises obtaining at least one of the at least one input or the at least one output from the one or more stored AD models. This can correspond to either one or both of blocks 108 or 109 of FIG. 1. One benefit of the method 400 is that it enables reuse and retraining of AD models built for one system to be used for other systems expediting the development of AD models for a target system and reducing the need for training data including anomalous data. For example, instead of training a model from the ground up, previously trained models may be obtained from a knowledge base at block 402 and the weights of the retrieved model can be used to train an AD model for the target system.

In some aspects, block 404 includes: classifying one or more subsets of the data as a data type of data types, wherein the data types comprise an input type, an output type, a label type, or a predicted output type, wherein the one or more subsets comprise the at least one input and the at least one output, wherein the at least one input is classified as the input type, and the at least one output is classified as the output type; selecting the AD framework based on the data types the one or more subsets are classified into; and selecting the one or more AD algorithms associated with the AD framework to train the one or more AD models according to the one or more AD algorithms, wherein the one or more AD algorithms utilize non-residual based unsupervised learning, non-residual based supervised learning, residual based unsupervised learning, or residual based supervised learning. The data types can correspond with the data types presented in FIG. 2 (206, 209, 210 and 212) and can correspond to the data types listed in columns 301-304 of FIG. 3. The AD framework can be selected form the set 201 of AD frameworks of FIG. 2, or the AD frameworks listed in column 305 of FIG. 3. The method 400 therefore leverages AD frameworks that deploy pre-designed AD training algorithms or combinations that can be applied in various contexts based on the specific AD framework, which reduces compute resource usage from selecting and integrating AD training algorithms and their components with data and data types.

In some aspects, the one or more subsets further comprise at least one label, wherein the at least one label is classified as the label type. The label type corresponds to label(s) L 212 of FIG. 2.

In some aspects, the one or more subsets further comprise at least one predicted output, wherein the at least one predicted output is classified as the predicted output type. The predicted output type corresponds to the output ŷ 210 of FIG. 2.

In some aspects, the AD framework is associated with one of: the input type and the output type and with the one or more AD algorithms that utilize the non-residual based unsupervised learning (e.g., the NR-UL 309 of FIG. 3); the input type, the output type, and the label type and with the one or more AD algorithms that utilize the non-residual based supervised learning (e.g., the NR-SL 308 of FIG. 3); the input type, the output type, and the predicted output type, and with the one or more AD algorithms that utilize the residual based unsupervised learning (e.g., the R-UL 307 of FIG. 3); or the input type, the output type, the label type, the predicted output type, and with the one or more AD algorithms that utilize the residual based supervised learning (e.g., the R-SL 306 of FIG. 3).

In some aspects, the one or more AD training algorithms are configured to utilize non-residual based unsupervised learning (e.g., the AD framework 203 utilizing NR-ULnon-residual based unsupervised learning of FIG. 2), and the AD framework is configured to be associated with the at least one input and the at least one output.

In some aspects, the data further comprises one or more of at least one label or at least one predicted output, e.g., one or more of the label(s) L 212 and the output ŷ 210 of FIG. 2.

In some aspects, the at least one predicted output is associated with a simulation model related to the target system.

In some aspects, the method 400 further includes determining a residual value associated with the predicted output, wherein the residual value comprises a difference between the at least one predicted output and the at least one output. The residual value can correspond to the residual value E 211 of FIG. 2.

In some aspects, the one or more AD training algorithms utilize non-residual based supervised learning (e.g., the AD framework 202 utilizing NR-SL of FIG. 2), and the AD framework is configured to be associated with the at least one input and the at least one output and the at least one label.

In some aspects, the one or more AD training algorithms utilize residual based unsupervised learning (e.g., the AD framework 204 utilizing R-UL of FIG. 2), and the AD framework is configured to be associated with the at least one input, the at least one output and the at least one predicted output.

In some aspects, the one or more AD training algorithms utilize residual based supervised learning (e.g., the AD framework 205 utilizing NR-UL of FIG. 2), and the AD framework is configured to be associated with the at least one input, the at least one output, the at least one predicted output, and the at least one label.

In some aspects, block 402 includes obtaining the data from a user. For example, this may correspond to obtaining data from a user 102 via a query or input 103 of FIG. 1.

In some aspects, method 400, or any aspect related to it, may be performed by an apparatus or processing system, such as processing system 500 of FIG. 5, which includes various components operable, configured, or adapted to perform the method 400. Processing system 500 is described below in further detail.

The method 400 provides a technical benefit of reducing compute resource usage by eliminating the need to repeatedly recreate system-specific AD models that can be applied in various contexts from the ground up by leveraging AD frameworks that utilize predefined and pre-tested AD training algorithms and algorithm combinations designed for the data types available to the method 400. Additionally, the method 400 relies on the domain knowledge and data of the target system or a simulation of the target system to not only determine the AD frameworks that select the most suitable AD algorithms but also to train the AD models based on this domain knowledge and data reducing the reliance on generic poor training data. The ability to leverage pre-trained models that are based on the same AD frameworks also reduces training time and amount required to generate AD models reducing overall compute resource usage.

Note that FIG. 4 is just one example of a method, and other methods including fewer, additional, or alternative operations are possible consistent with this disclosure.

### Example Processing System for Autonomous AD Model Generation

FIG. 5 depicts an example processing system 500 configured to perform various aspects described herein, including, for example, the method 400 as described above with respect to FIG. 4.

Processing system 500 is an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 500 includes one or more processors 502, one or more input/output devices 504, one or more display devices 506, one or more network interfaces 508 through which processing system 500 is connected to one or more networks (e.g., a local network, an intranet, the Internet, or any other group of processing systems communicatively connected to each other), and computer-readable medium 512. In the depicted example, the aforementioned components are coupled by a bus 510, which may generally be configured for data exchange amongst the components. Bus 510 may be representative of multiple buses, while only one is depicted for simplicity.

Processor(s) 502 are generally configured to retrieve and execute instructions stored in one or more memories, including local memories like computer-readable medium 512, as well as remote memories and data stores. Similarly, processor(s) 502 are configured to store application data residing in local memories like the computer-readable medium 512, as well as remote memories and data stores. More generally, bus 510 is configured to transmit programming instructions and application data among the processor(s) 502, display device(s) 506, network interface(s) 508, and/or computer-readable medium 512. In certain embodiments, processor(s) 502 are representative of a one or more central processing units (CPUs), graphics processing unit (GPUs), tensor processing unit (TPUs), accelerators, and other processing devices.

Input/output device(s) 504 may include any device, mechanism, system, interactive display, and/or various other hardware and software components for communicating information between processing system 500 and a user of processing system 500. For example, input/output device(s) 504 may include input hardware, such as a keyboard, touch screen, button, microphone, speaker, and/or other device for receiving inputs from the user and sending outputs to the user.

Display device(s) 506 may generally include any sort of device configured to display data, information, graphics, user interface elements, and the like to a user. For example, display device(s) 506 may include internal and external displays such as an internal display of a tablet computer or an external display for a server computer or a projector. Display device(s) 506 may further include displays for devices, such as augmented, virtual, and/or extended reality devices. In various embodiments, display device(s) 506 may be configured to display a graphical user interface.

Network interface(s) 508 provide processing system 500 with access to external networks and thereby to external processing systems. Network interface(s) 508 can generally be any hardware and/or software capable of transmitting and/or receiving data via a wired or wireless network connection. Accordingly, network interface(s) 508 can include a communication transceiver for sending and/or receiving any wired and/or wireless communication.

Computer-readable medium 512 may be a volatile memory, such as a random access memory (RAM), or a nonvolatile memory, such as nonvolatile random access memory (NVRAM), or the like. In this example, computer-readable medium 512 includes obtaining component 514, performing component 516, training component 518, rank ordering component 520, executing component 522, and determining component 524.

In certain embodiments, obtaining component 514 is configured to obtain data comprising at least one input and at least one output, the at least one input and the at least one output associated with a target system, such as described with reference to block 402 of FIG. 4.

In certain embodiments, performing component 516 is configured to perform triage to select an AD framework from a set of AD frameworks, wherein the AD framework is based on the at least one input and the at least one output and wherein the AD framework comprises one or more AD training algorithms, such as described with reference to block 404 of FIG. 4.

In certain embodiments, training component 518 is configured to train one or more AD models based on the one or more AD training algorithms of the AD framework, such as described with reference to block 406 of FIG. 4.

In certain embodiments, rank ordering component 520 is configured to rank order the one or more AD models based on at least one of a benchmark set of data associated with the target system, pre-set metrics, or user-defined values, such as described with reference to block 408 of FIG. 4.

In certain embodiments, executing component 522 is configured to execute the AD model on at least one data input associated with the target system as described in FIG. 4.

In certain embodiments, determining component 524 is configured to determine a residual value associated with the predicted output, wherein the residual value comprises a difference between the at least one predicted output and the at least one output as described in FIG. 4.

Note that FIG. 5 is just one example of a processing system consistent with aspects described herein, and other processing systems having additional, alternative, or fewer components are possible consistent with this disclosure.

### Example Clauses

Implementation examples are described in the following numbered clauses:
Clause 1: A method for generating anomaly detection models comprising: obtaining data comprising at least one input and at least one output, the at least one input and the at least one output associated with a target system; performing triage to select an anomaly detection (AD) algorithm framework (AD framework) from a set of AD frameworks, wherein the AD framework is based on the at least one input and the at least one output and wherein the AD framework comprises one or more AD training algorithms; training one or more AD models based on the one or more AD training algorithms of the AD framework; and rank ordering the one or more AD models based on at least one of a benchmark set of data associated with the target system, pre-set metrics, or user-defined values.
Clause 2: The method of Clause 1, further comprising: obtaining a selection of an AD model of the one or more AD models from a user; and executing the AD model on at least one data input associated with the target system.
Clause 3: The method of any one of Clauses 1-2, further comprising: obtaining one or more stored AD models from a knowledge base, wherein the method comprises obtaining at least one of the at least one input or the at least one output from the one or more stored AD models.
Clause 4: The method of any one of Clauses 1-3, wherein performing the triage comprises: classifying one or more subsets of the data as a data type of data types, wherein the data types comprise an input type, an output type, a label type, or a predicted output type, wherein the one or more subsets comprise the at least one input and the at least one output, wherein the at least one input is classified as the input type, and the at least one output is classified as the output type; selecting the AD framework based on the data types the one or more subsets are classified into; and selecting the one or more AD algorithms associated with the AD framework to train the one or more AD models according to the one or more AD algorithms, wherein the one or more AD algorithms utilize non-residual based unsupervised learning, non-residual based supervised learning, residual based unsupervised learning, or residual based supervised learning.
Clause 5: The method of Clause 4, wherein the one or more subsets further comprise at least one label, wherein the at least one label is classified as the label type.
Clause 6: The method of Clause 4, wherein the one or more subsets further comprise at least one predicted output, wherein the at least one predicted output is classified as the predicted output type.
Clause 7: The method of Clause 4, wherein the AD framework is associated with one of: the input type and the output type and with the one or more AD algorithms that utilize the non-residual based unsupervised learning; the input type, the output type, and the label type and with the one or more AD algorithms that utilize the non-residual based supervised learning; the input type, the output type, and the predicted output type, and with the one or more AD algorithms that utilize the residual based unsupervised learning; or the input type, the output type, the label type, the predicted output type, and with the one or more AD algorithms that utilize the residual based supervised learning.
Clause 8: The method of any one of Clauses 1-7, wherein: the one or more AD training algorithms are configured to utilize non-residual based unsupervised learning, and the AD framework is configured to be associated with the at least one input and the at least one output.
Clause 9: The method of any one of Clauses 1-8, wherein the data further comprises one or more of at least one label or at least one predicted output.
Clause 10: The method of Clause 9, wherein the at least one predicted output is associated with a simulation model related to the target system.
Clause 11: The method of Clause 10, wherein one or more processors are further configured causing the apparatus to: determine a residual value associated with the predicted output, wherein the residual value comprises a difference between the at least one predicted output and the at least one output.
Clause 12: The method of Clause 10, wherein: the one or more AD training algorithms utilize non-residual based supervised learning, and the AD framework is configured to be associated with the at least one input and the at least one output and the at least one label.
Clause 13: The method of Clause 10, wherein: the one or more AD training algorithms utilize residual based unsupervised learning, and the AD framework is configured to be associated with the at least one input, the at least one output and the at least one predicted output.
Clause 14: The method of Clause 10, wherein: the one or more AD training algorithms utilize residual based supervised learning, and the AD framework is configured to be associated with the at least one input, the at least one output, the at least one predicted output, and the at least one label.
Clause 15: The method of any one of Clauses 1-14, wherein obtaining the data comprises obtaining the data from a user.
Clause 16: One or more processing systems, comprising: one or more memories comprising computer-executable instructions; and one or more processors configured to execute the computer-executable instructions and cause the one or more processing systems to perform a method in accordance with any one of Clauses 1-15.
Clause 17: One or more processing systems, comprising means for performing a method in accordance with any one of Clauses 1-15.
Clause 18: One or more non-transitory computer-readable media comprising instructions that, when executed by one or more processors of a computing system, cause the computing system to perform the operations of any one of Clauses 1-15.
Clause 19: One or more computer program products embodied on one or more computer-readable storage media comprising code for performing a method in accordance with any one of Clauses 1-15.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, unless stated otherwise, the term “or” is used in an inclusive sense. This inclusive usage of or is equivalent to “and/or”. Thus, when options are delineated using “or,” it permits the selection of one or more of the enumerated options concurrently. For example, if the document stipulates that a component may comprise option A or option B, it shall be understood to mean that the component may comprise option A, option B, or both option A and option B, and does not mean, unless stated expressly that the component includes either option A or option B. This inclusive interpretation ensures that all potential combinations of the options are permissible, rather than restricting the choice to a singular, exclusive option.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising one or more processors, and one or more memories coupled with the one or more processors, the one or more processors configured to cause the processing system to:
obtain data comprising at least one input and at least one output, the at least one input and the at least one output associated with a target system;
perform triage to select an anomaly detection (AD) algorithm framework (AD framework) from a set of AD frameworks, wherein the AD framework is based on the at least one input and the at least one output and wherein the AD framework comprises one or more AD training algorithms;
train one or more AD models based on the one or more AD training algorithms of the AD framework; and
rank order the one or more AD models based on at least one of a benchmark set of data associated with the target system, pre-set metrics, or user-defined values.

2. The processing system of claim 1, wherein the one or more processors are further configured to cause the processing system to:
obtain a selection of an AD model of the one or more AD models from a user; and
execute the AD model on at least one data input associated with the target system.

3. The processing system of claim 1, wherein the one or more processors are further configured to cause the processing system to:
obtain one or more stored AD models from a knowledge base, wherein the processing system is caused to obtain at least one of the at least one input or the at least one output from the one or more stored AD models.

4. The processing system of claim 1, wherein to perform the triage, the one or more processors are configured to cause the processing system to:
classify one or more subsets of the data as a data type of data types, wherein the data types comprise an input type, an output type, a label type, or a predicted output type, wherein the one or more subsets comprise the at least one input and the at least one output, wherein the at least one input is classified as the input type, and the at least one output is classified as the output type;
select the AD framework based on the data types the one or more subsets are classified into; and
select the one or more AD algorithms associated with the AD framework to train the one or more AD models according to the one or more AD algorithms, wherein the one or more AD algorithms utilize non-residual based unsupervised learning, non-residual based supervised learning, residual based unsupervised learning, or residual based supervised learning.

5. The processing system of claim 4, wherein the one or more subsets further comprise at least one label, wherein the at least one label is classified as the label type.

6. The processing system of claim 4, wherein the one or more subsets further comprise at least one predicted output, wherein the at least one predicted output is classified as the predicted output type.

7. The processing system of claim 4, wherein the AD framework is associated with one of:
the input type and the output type and with the one or more AD algorithms that utilize the non-residual based unsupervised learning;
the input type, the output type, and the label type and with the one or more AD algorithms that utilize the non-residual based supervised learning;
the input type, the output type, and the predicted output type, and with the one or more AD algorithms that utilize the residual based unsupervised learning; or
the input type, the output type, the label type, the predicted output type, and with the one or more AD algorithms that utilize the residual based supervised learning.

8. The processing system of claim 1, wherein:
the one or more AD training algorithms are configured to utilize non-residual based unsupervised learning, and
the AD framework is configured to be associated with the at least one input and the at least one output.

9. The processing system of claim 1, wherein the data further comprises one or more of at least one label or at least one predicted output.

10. The processing system of claim 9, wherein the at least one predicted output is associated with a simulation model related to the target system.

11. The processing system of claim 10, wherein one or more processors are further configured to cause the processing system to:
determine a residual value associated with the predicted output,
wherein the residual value comprises a difference between the at least one predicted output and the at least one output.

12. The processing system of claim 10, wherein:
the one or more AD training algorithms utilize non-residual based supervised learning, and
the AD framework is configured to be associated with the at least one input and the at least one output and the at least one label.

13. The processing system of claim 10, wherein:
the one or more AD training algorithms utilize residual based unsupervised learning, and
the AD framework is configured to be associated with the at least one input, the at least one output and the at least one predicted output.

14. The processing system of claim 10, wherein:
the one or more AD training algorithms utilize residual based supervised learning, and
the AD framework is configured to be associated with the at least one input, the at least one output, the at least one predicted output, and the at least one label.

15. The processing system of claim 1, wherein to obtain the data, the one or more processors are configured to cause the processing system to obtain the data from a user.

16. A method for generating anomaly detection models comprising:
obtaining data comprising at least one input and at least one output, the at least one input and the at least one output associated with a target system;
performing triage to select an anomaly detection (AD) algorithm framework (AD framework) from a set of AD frameworks, wherein the AD framework is based on the at least one input and the at least one output and wherein the AD framework comprises one or more AD training algorithms;
training one or more AD models based on the one or more AD training algorithms of the AD framework; and
rank ordering the one or more AD models based on at least one of a benchmark set of data associated with the target system, pre-set metrics, or user-defined values.

17. The method of claim 16, further comprising:
classifying one or more subsets of the data as a data type of data types, wherein the data types comprise an input type, an output type, a label type, or a predicted output type, wherein the one or more subsets comprise the at least one input and the at least one output, wherein the at least one input is classified as the input type, and the at least one output is classified as the output type;
selecting the AD framework based on the data types the one or more subsets are classified into; and
selecting the one or more AD algorithms associated with the AD framework to train the one or more AD models according to the one or more AD algorithms, wherein the one or more AD algorithms utilize non-residual based unsupervised learning, non-residual based supervised learning, residual based unsupervised learning, or residual based supervised learning.

18. The method of claim 17, wherein the one or more subsets further comprise one or more of at least one label and at least one predicted output, wherein one or more of the at least one label is classified as the label type or the at least one predicted output is classified as the predicted output type.

19. The method of claim 17, wherein the AD framework is associated with one of:
the input type and the output type and with the one or more AD algorithms that utilize the non-residual based unsupervised learning;
the input type, the output type, and the label type and with the one or more AD algorithms that utilize the non-residual based supervised learning;
the input type, the output type, and the predicted output type, and with the one or more AD algorithms that utilize the residual based unsupervised learning; or
the input type, the output type, the label type, the predicted output type, and with the one or more AD algorithms that utilize the residual based supervised learning.

20. A non-transitory computer-readable medium comprising instructions that, when executed by one or more processors of a computing system, cause the computing system to perform operations for generation of anomaly detection (AD) models, the operations comprising:
obtaining data comprising at least one input and at least one output, the at least one input and the at least one output associated with a target system;
performing triage to select an AD algorithm framework (AD framework) from a set of AD frameworks, wherein the AD framework is based on the at least one input and the at least one output and wherein the AD framework comprises one or more AD training algorithms;
training one or more AD models based on the one or more AD training algorithms of the AD framework; and
rank ordering the one or more AD models based on at least one of a benchmark set of data associated with the target system, pre-set metrics, or user-defined values.
